(19) United States
(12) Patent Application Publication
(10) Pub. No.: US 2026/0195100 A1
(43) Pub. Date: Jul. 9, 2026

(54) FRONT-END CODE GENERATION BASED ON DESIGN DIAGRAM

(71) Applicant: International Business Machines Corporation, Armonk, NY (US)

(72) Inventors: Kun Yan Yin, NINGBO (CN); Xiao Bo Li, Ningbo (CN); Yuan Yuan Ding, Shanghai (CN); Jing Zhang, Shanghai (CN); Shi Yun Liang, Shanghai (CN); Xue Ying Li, Beijing (CN)

(21) Appl. No.: 19/009,337

(22) Filed: Jan. 3, 2025

(51) Int. Cl. G06F 8/34

(52) U.S. Cl. CPC G06F 8/34

(57) ABSTRACT

An example operation includes one or more of receiving a diagram of a software system, the diagram comprising an image of a user interface (UI) layout of the software, extracting UI components of the software system and styling attributes of the UI components from the UI layout by execution of a machine learning model on the diagram of the software system, retrieving code templates of the UI components from a database, generating source code for the software system based on the code templates and the styling attributes of the UI components, where the source code defines a layout of the UI components on a page, and inserting the source code into an executable computer file of the software system to generate modified source code of the software system.

### BACKGROUND

Large enterprises and organizations often rely on their own best practices when it comes to coding standards, application programming interfaces (APIs), custom user interfaces (UIs) components, tables, forms, and the like. These limitations often require developers to consider multiple sources of information when generating code, causing numerous inefficiencies.

### SUMMARY

One example embodiment provides a method that may include one or more of receiving a diagram of a software system, the diagram comprising an image of a user interface (UI) layout of the software system, extracting UI components of the software system and styling attributes of the UI components from the UI layout by execution of a machine learning model on the diagram of the software system, retrieving code templates of the UI components from a database, generating source code for the software system based on the code templates and the styling attributes of the UI components, where the source code defines a layout of the UI components on a page, and inserting the source code into an executable computer file of the software system to generate modified source code of the software system.

Another example embodiment provides a computer system that may include a processor set, a set of one or more computer-readable storage media, and program instructions, collectively stored in the set of one or more storage media, that cause the processor set to perform computer operations that may include one or more of receiving a diagram of a software system, the diagram comprising an image of a user interface (UI) layout of the software system, extracting UI components of the software system and styling attributes of the UI components from the UI layout by execution of a machine learning model on the diagram of the software system, retrieving code templates of the UI components from a database, generating source code for the software system based on the code templates and the styling attributes of the UI components, where the source code defines a layout of the UI components on a page, and inserting the source code into an executable computer file of the software system to generate modified source code of the software system.

A further example embodiment provides a computer program product that may include a set of one or more computer-readable storage media, and program instructions, collectively stored in the set of one or more computer-readable storage media, for causing a processor set to perform computer operations that may include one of more of receiving a diagram of a software system, the diagram comprising an image of a user interface (UI) layout of the software system, extracting UI components of the software system and styling attributes of the UI components from the UI layout by execution of a machine learning model on the diagram of the software system, retrieving code templates of the UI components from a database, generating source code for the software system based on the code templates and the styling attributes of the UI components, where the source code defines a layout of the UI components on a page, and inserting the source code into an executable computer file of the software system to generate modified source code of the software system.

### BRIEF DESCRIPTION OF THE DRAWINGS

FIG. 1 is a diagram illustrating a computing environment according to an embodiment of the instant solution.

FIG. 2 is a diagram illustrating a system for converting a software design diagram into source code according to examples and features of the instant solution.

FIG. 3A is a diagram illustrating a process of generating searchable vectors with API code and code scripts according to examples and features of the instant solution.

FIG. 3B is a diagram illustrating a process of generating a virtual table from design diagram content according to examples and features of the instant solution.

FIG. 3C is a diagram illustrating a process of integrating API code and code scripts into the virtual table according to examples and features of the instant solution.

FIG. 3D is a diagram of prompting a multi-modal computer model to generate source code according to examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a system, for example, a software application, or the like, which can generate source code for a graphical user interface (GUI) of a software project based on a layout diagram of the GUI. The system can ingest specific coding standards, API documents, and the like, associated with GUI components and generate the source code based on such additional content. The system may execute a machine learning model or group of machine learning models on the input data to generate the source code for the GUI. The source code may be in a format of a programming language, for example, Hypertext Markup Language (HTML), Cascading Style Sheets (CSS), JavaScript, and the like.

For example, knowledge content such as coding standards documentation, API documents, code templates, and the like, may be extracted from different sources and converted into vectors or embeddings which can be stored in a vector database. By converting the content from text and images into vectors, the system can convert the content into a format that is ready for execution by a machine-readable processing device. The vectorization process may be performed in advance and may be stored along with the machine learning model which generates the code.

In addition, the system described herein can receive a request for generating source code, for example, from a graphical user interface (GUI) of a software application. The request may include a design diagram of a software system for which the source code is to be generated. The system may execute a machine learning model based on the content included in the design diagram and additional code templates, API documentation, etc. related to the software system to generate source code for the software system.

In some embodiments, the additional code templates, API documentation, and the like, may be vectorized in advance. Thus, the system may obtain related vectors from the vector database using a similarity search. For example, the vectorization of the additional code templates, API documentation, and the like may include names of the files of code being stored. The vector database may perform a similarity search in vector space between the name of the software system and the vectors of the additional code templates and API documentation to identify the vectors from the vector database.

In some embodiments, the design diagram may be transmitted from a communication channel between the system described herein and an integrated development environment (IDE). Here, the IDE may download the design diagram into the software application using a plugin. The software application may then convert the design diagram into a virtual table containing descriptions of its components, along with additional code templates, and API documentation, and feed the virtual table into the machine learning model.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

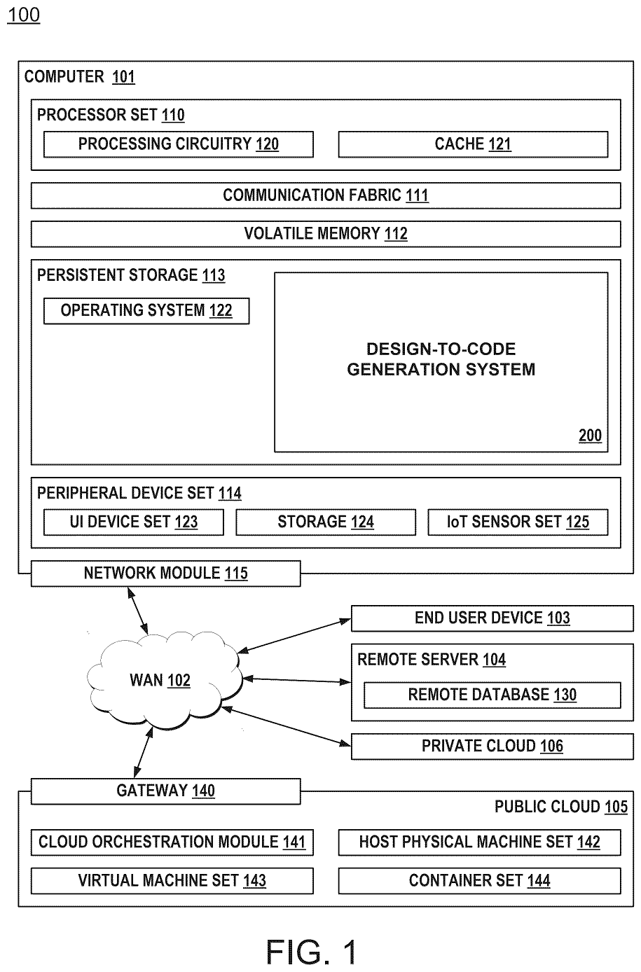

Referring to FIG. 1, computing environment 100 contains an example of an environment for the execution of at least some of the computer code involved in performing the inventive methods, such as design-to-code generation system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system that is able to generate code (e.g., HTML, CSS, JavaScript, etc.) for a user interface of a software system using a design diagram of the user interface of the software system along with APIs, scripts, code templates of UI components, and the like (which may be related to an enterprise or a particular system). The system may also include a plugin which can insert or otherwise integrate the source code into a software project at a location at which the source code belongs within the software project. The system can significantly speed up the coding process for coding a user interface by converting a design diagram into source code using machine learning (for example, generative machine learning). The system can provide an end-to-end workflow for designing the source code and can unify standards of different developers within the same organization using code templates, API documentation, best practices, and the like, of the organization, when generating the source code.

For example, the system may receive a diagram of a software system from a data source such as an integrated development environment (IDE), however embodiments are not limited thereto. The system may include a plugin that is installed in the IDE or in another software application that enables design diagrams to be downloaded from the IDE to the system through the plugin. The design diagram may include an image of a user interface (UI) layout of the software system and styling attributes of the UI layout. The styling attributes may include coordinate locations at which components are located on the UI, coloring schemes, font, buttons, menus, and the like. The system may extract UI components of the software system from the design diagram by execution of a multi-modal computer model (e.g., a ML model, etc.) on the design diagram of the software system. The system may then generate source code for the UI of the software system where the source code defines a layout of the UI components on a page of the UI of the software system. Furthermore, the system may insert the source code into an executable computer file of the software system to generate modified source code of the software system.

In some embodiments, the system may retrieve executable scripts and application programming interfaces (APIs) associated with the UI components from a storage device, wherein the generating the source code further comprises generating the source code to include the executable scripts and the APIs associated with the UI components. In some embodiments, the system may convert the UI components into component vectors within an embedding space and identify the executable scripts and the APIs based on vectors of the executable scripts and the APIs being within a predetermined distance from the component vectors within the embedding space.

In some embodiments, the system may construct a virtual table that includes identifiers and attributes of each UI component and execute the multi-modal computer model on the virtual table to produce an output that includes the source code. In some embodiments, the system may generate one or more prompts that include a template description with a definition of the content to be included in the source code and the extracted UI components and generate the source code based on execution of the multi-modal computer model on the prompt.

In some embodiments, the system may extract a plurality of computer files of the software system from a repository and build a graph structure of the software system based on relationships between the plurality of computer files. For example, the graph structure includes nodes with names of the plurality of computer files and edges between the nodes that represent dependencies between the plurality of computer files. In some embodiments, the system may match the source code to a computer file among the plurality of computer files based on a name of the source code and the names of the plurality of computer files in the graph structure.

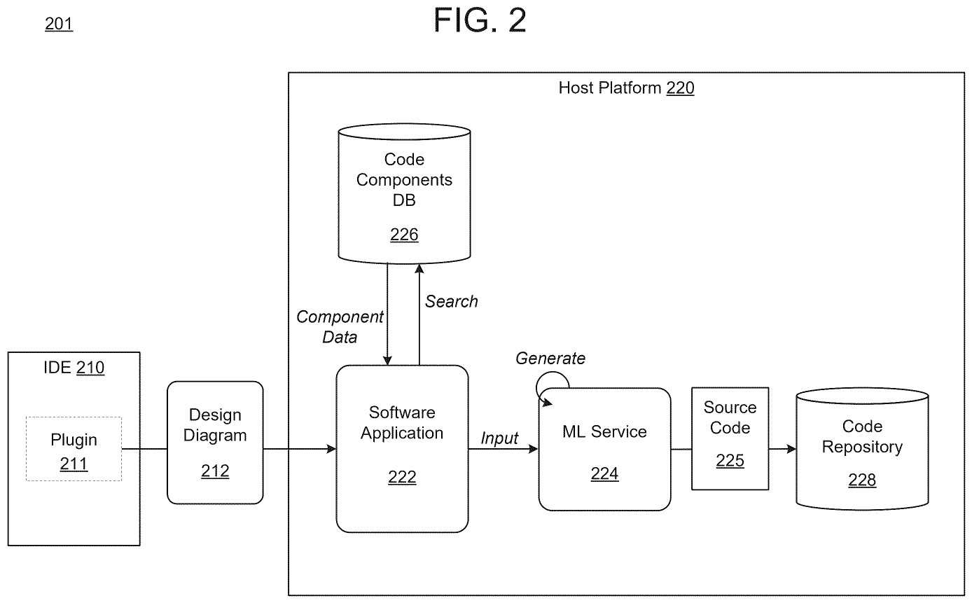

FIG. 2 illustrates a system 201 for converting a software design diagram into source code according to examples and features of the instant solution. Referring to FIG. 2, a host platform 220 may host a software application 222, which is able to generate source code 225 from a design diagram 212 of a software system. The host platform 220 may be a cloud platform, a web server, a database, a distributed system, an on-premises server, or the like. A user may connect to the software application 222 on the host platform 220 through a device, a software application, an IDE, or the like. In the example of FIG. 2, the user connects to the software application 222 through an IDE 210.

According to various embodiments, the software application 222 may include a machine learning (ML) service 224 which receives the design diagram 212 and generates the source code 225. The ML service 224 may include one or more ML models including a generative ML model. The source code 225 that is generated by the ML service 224 may include source code for rendering a user interface (UI) of the software system being designed via the IDE 210, for example, HTML code, CSS code, JavaScript code, and the like which includes source code for rendering the UI components and also styling attributes of the UI/UI components. In some embodiments, the ML service 224 may be a single ML model. As another example, the ML service 224 may include a group of ML models that are arranged in sequence and which perform different tasks on the input to generate the output.

According to various embodiments, the design diagram 212 may be transmitted from the IDE 210 in response to a command from a user entered via a GUI of the IDE 210, which is not shown. The IDE 210 may include a software component such as a plugin 211 of the software application 222, which enables the IDE 210 to transfer the design diagram 212 to the software application 222 on the host platform 220. The design diagram 212 may include visual components (e.g., UI components, buttons, menus, etc.), styling attributes (e.g., spacing, location coordinates of GUI elements, color palette, etc.), textual data (e.g., descriptions, etc.), and the like. The design diagram 212 may visually depict a layout of a front-end of the software system being developed within the IDE 210.

In response to receiving the design diagram 212, the software application 222 may identify relevant code templates, API documents, executable scripts, and the like, which are associated with the components in the design diagram 212. For example, the software application 222 may identify the code templates, API documents, scripts, etc. from a code component database 226.

In some embodiments, the code component database 226 may be a vector database. The vectors stored in the vector database may include vectorized code templates, vectorized API documents, vectorized scripts, and the like, including names, IDs, summaries, and the like. The software application 222 may use names of UI components in the design diagram 212 to perform a similarity search for relevant code templates, API documents, scripts, etc. within the vector database. The search process may involve converting the UI components (e.g., names, descriptions, etc.) into vectors and then performing the vector search using the vectors.

The software application may generate an input (e.g., a virtual table, etc.) with attributes of the UI components in the design diagram 212, the code templates, the API documents, the scripts, and the like and feed the input to the ML service 224. In response, the ML service 224 may generate the source code 225. Furthermore, the software application 222 may include graphing capabilities, which can be used to graph a directory of the software project (e.g., folders, files, etc.) and perform a graph search using the source code 225 and the graph of the directory to identify a location (e.g., a computer file, folder, etc.) within the software project where the source code 225 should be added. In this example, the directory where the source code 225 is stored may be included in a code repository 228.

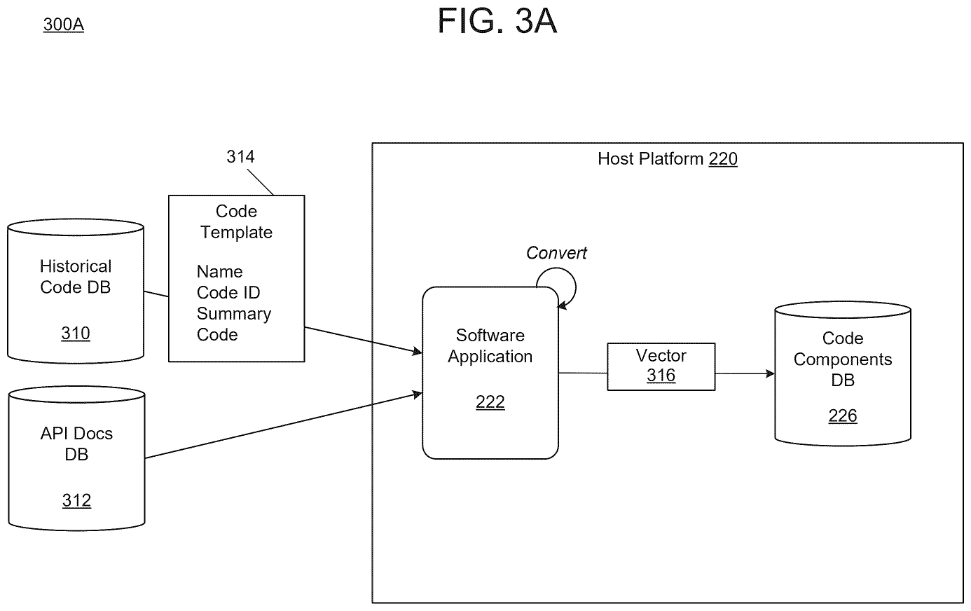

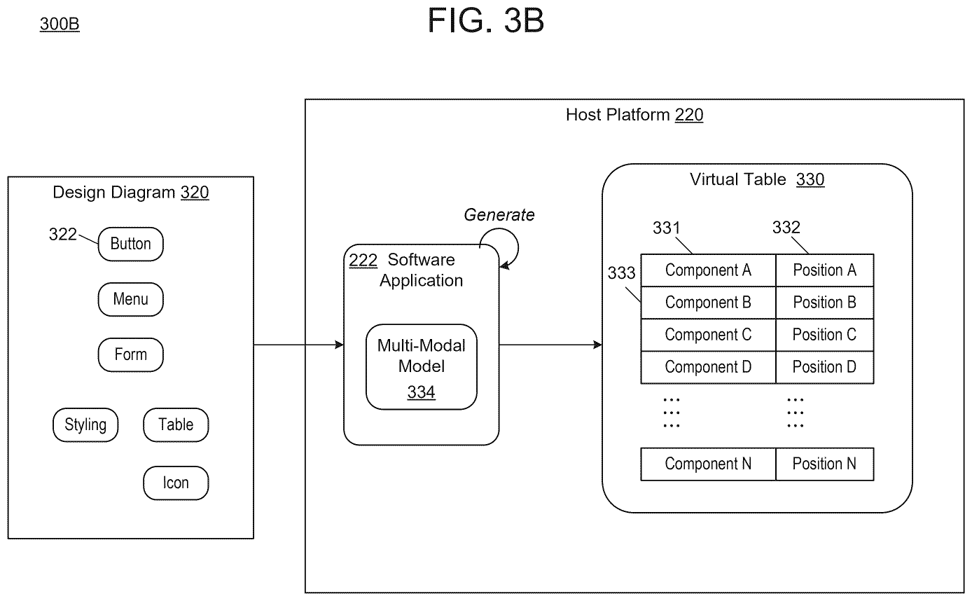

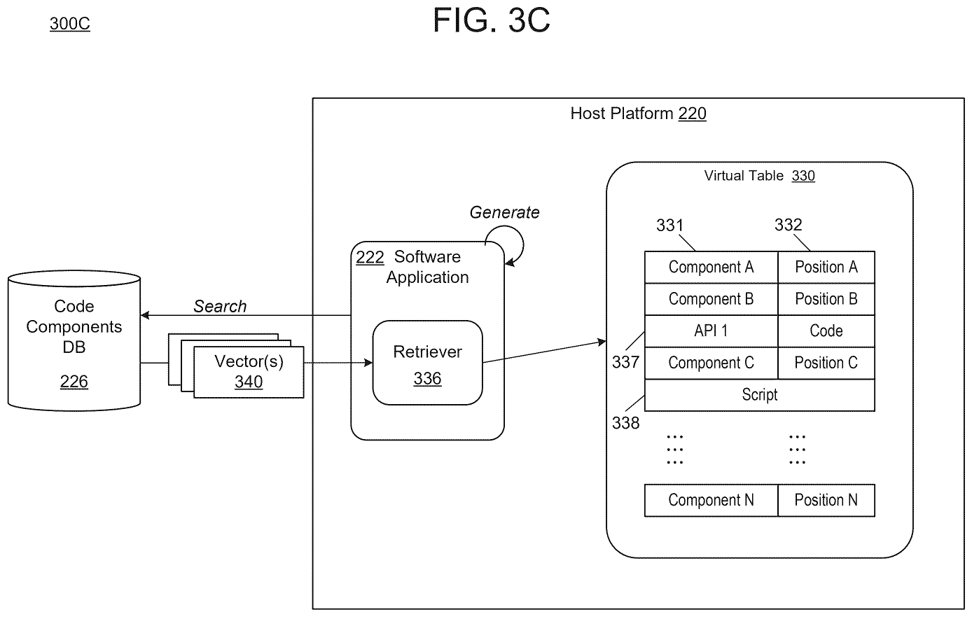

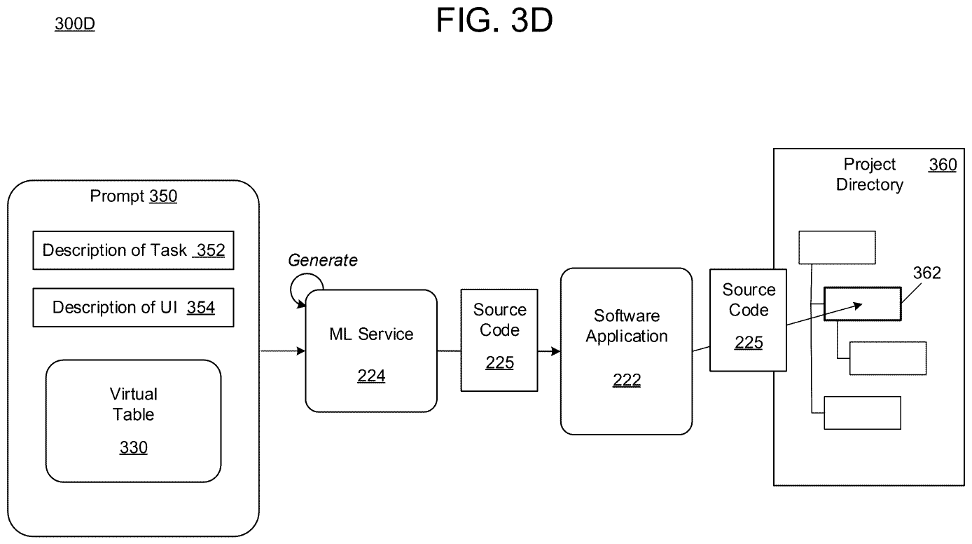

FIG. 3A illustrates a process 300A of generating searchable vectors with API code and code scripts according to examples and features of the instant solution. Referring to FIG. 3A, the software application 222 may build a knowledge base of code templates, API documents, executable scripts, and the like which are related to front-end UI components. For example, the software application 222 may ingest code templates from a historical code database 310. An example of the ingested content is code template 314 which may include HTML code, CSS code, JavaScript code, or the like. The code template 314 may include code for rendering a UI component such as a button, a menu, a layout, a color palette, and the like. The code template 314 may include an identifier (ID) of the code such as a unique serial number or the like, a name of the code, a summary of what the code relates to, the code itself, and the like. In addition, the software application 222 may ingest code templates of UI components from other data sources such as API documentation from a database 312, scripts for executing the UI components from a database (not shown), and the like.

The system can gather and manage component information, such as IDs, names, summaries, and code templates, by maintaining a component registry or component library. This library acts as a centralized repository where each component's metadata and code template are stored and can be updated, as necessary. For example, the code templates may refer to a predefined code snippet or structure that defines how a component should be rendered or implemented in the front-end. The code of the code components may include HTML, CSS, and JavaScript for the component's layout, styling, and behavior. The code template is used as a starting point or blueprint when generating actual code, allowing the system to quickly integrate the correct structure and style for components like buttons, forms, or tables into the final output, ensuring consistency with a coding standard(s).

In the examples herein, “code components” refer to front-end UI components and reusable code elements that has been developed (for example, by an enterprise) to standardize and streamline front-end development. These components can include UI widgets (e.g., buttons, tables), entire forms or layout sections, typically including built-in styling, behavior, API integration logic, and the like.

According to various embodiments, the software application 222 may extract component data from the code components and convert the component data into vectors that are stored within the code component database 226. For example, the software application 222 may extract component data by gathering detailed information about a component, such as its functionality, structure, code template, behavior, and attributes (e.g., HTML, CSS, JavaScript) from the code template. This includes the full implementation of the component. In addition, the software application 222 may extract a name and/or a description of the code component (e.g., “Primary Button”) and summary (e.g., “A button for main actions”).

As another example, the software application 222 may extract scripts or component code scripts which are found in predefined templates or code snippets that are part of the system's library. These scripts, representing reusable UI components, are typically designed and developed according to coding standards (for example, from an enterprise), so they are consistent and aligned with requirements (for example, for a project). The component code may include an HTML structure which defines the component's layout (e.g., <button>, <form>), CSS styling which specifies the component's visual design (e.g., colors, sizes), JavaScript/interactivity, which handles dynamic behavior and interactions (e.g., click events), a description, which includes a summary of the component's purpose and usage, attributes and states, which include attributes like ID, class, and different component states (e.g., active, disabled), and accessibility data, which ensures the component is accessible (e.g., aria-label, role).

The software application 222 may include a model, such as an embedding model, which is specialized in converting text data into vector representations in vector space/embedding space. The model may be optimized for generating embeddings. The software application 222 may input the extracted content from the code template 314 into the embedding model, and the embedding model may generate a vector 316 that represents the code template 314 in vector space.

FIG. 3B illustrates a process 300B of generating a virtual table from content included in a design diagram 320 according to examples and features of the instant solution. According to various embodiments, the process of converting a design diagram into source code may be initiated by a user uploading a design diagram to the software application 222. For example, the design diagram may be uploaded from another software application or system such as an IDE, but embodiments are not limited thereto. As another example, the design diagram may be stored locally, on a publicly available site, in a database, or the like, and transferred to the software application 222 using any traditional means.

Referring to FIG. 3B, the software application 222 may receive the design diagram 320 and extract UI components, styling attributes, UI layout, and the like, from the design diagram 320. In this example, the design diagram 320 includes UI components 322 on a user interface. The design diagram 320 (or design image) is a visual representation of the intended UI layout. It includes UI components such as buttons, forms, tables, icons, and the overall page structure, showing how each component should look and where it should be placed.

The design diagram 320 may also contain styling cues, such as colors, fonts, and spacing, providing a blueprint for translating the visual design into code. The design diagram 320 is not a simple picture but a detailed mockup of the software interface. In some embodiments, the design diagram 320 may be uploaded from an IDE and is typically triggered by a user action, such as entering a command, clicking an option in the plugin menu, or using a shortcut within the IDE.

In this example, the software application 222 may use a multi-modal computer model 334 such as a multi-modal LLM, or the like, to convert the images and text content within the design diagram 320 into tabular data (e.g., alphanumeric characters, etc.) which can be stored within a virtual table 330. The software application 222 may generate a virtual table instance for each design diagram that is collected. In this example, the virtual table includes columns 331 and 332 for storing component data such as IDs, names, summaries, etc., layout data such as coloring, shading, styling, etc., behavioral data, code snippets, and the like. The virtual table 330 also includes rows 333 corresponding to UI components, with each component's data stored (independently or coupled with other data) in a row of the virtual table 330.

In this example, the multi-modal computer model 334, such as a multi-modal LLM, may be used to interpret and understand both visual elements (such as images in the design diagram) and textual information (such as descriptions or labels associated with components). This allows the multi-modal computer model 334 to accurately identify UI components (e.g., buttons, forms, tables) within the visual design, understand their spatial arrangement, and link them to relevant component standards or code templates. By combining visual and textual understanding, the multi-modal computer model 334 ensures accurate extraction of design elements, enabling precise and contextually relevant code generation based on the uploaded diagram.

Extracting sections and components from the HTML equates to identifying and isolating specific parts of the HTML code that correspond to distinct UI sections (like headers, footers, or main content areas) and individual components (such as buttons, forms, tables) within those sections. This process involves parsing the HTML structure to locate and categorize these elements based on tags, class names, IDs, and hierarchical layout. The parsed data may then be stored within the virtual table 330. The purpose of the virtual table 330 is to represent the overall structure and organization of the UI design in a clear, structured format that can be easily processed by the system. This table stores information about each section and component in the design, including their positions, hierarchies, and relationships, as well as details about each component's content and functionality. The table may be “virtual” such as a conceptual or data-based structure, instead of a physical table or visual diagram. It may be created in-memory, for example, in a JavaScript Object Notation (JSON) file to organize and manage components without requiring an actual rendering of the UI.

FIG. 3C illustrates a process 300C of integrating additional content such as API documents, code scripts, code templates, and the like into the virtual table 330 according to examples and features of the instant solution. Referring to FIG. 3C, the design to code generation process may be enhanced by ingesting additional content associated with the UI components in the design diagram 320 and storing the additional content into the virtual table 330. For example, the software application 222 may include a retriever 336 module which is capable of retrieving vectors from a vector database, such as the code components database 226. The code components database 226 stores vectors with vectorized content from API documents, executable code scripts, code templates, and the like.

For example, the retriever 336 may perform a similarity search for vectors stored in the code components database 226 with respect to a name of a UI component in the design diagram 320. The retriever 336 may retrieve a name, a summary, an ID, or the like, of a UI component from the virtual table 330, and convert it into a vector. The retriever 336 may then identify other vectors 340 within the code component database 226 which have the same or similar direction or similar location in the embedding space as the vector and use the additional vectors 340 to further enhance the virtual table 330 by storing the additional vectors 340 in the virtual table 330. The software application 222 may have added rows 337 and 338 that include API document data, code templates, executable code scripts, and the like.

The API documents may contain detailed specifications for an API's endpoints and functionality, following a format such as OpenAPI Specification (OAS) format. These documents are typically written in JSON or YAML format and describe information needed to understand, test, and integrate with an API effectively. The content extracted from the documentation may include key semantic and structural information rather than the entire document, focusing on details that define each endpoint's functionality, required inputs, and expected outputs, such as endpoint paths and methods, URI paths and HTTP verbs, ID and descriptions, parameters, schemas, status codes and responses, etc.

The software application 222 may use JSON to describe the entirety of the virtual table 330, creating a structured JSON representation that outlines each component's details and their layout within the UI. This JSON document serves as a blueprint, capturing both the content and spatial arrangement of the components as a machine-readable format. This approach allows the system to effectively map out the UI layout and component interactions, enabling precise code generation that matches the design structure.

FIG. 3D illustrates a process 300D of prompting the ML service 224 to generate the source code 225 according to examples and features of the instant solution. Furthermore, in the example of FIG. 3D, the software application 222 is also capable of identifying a location for adding the source code 225 within the software project, such as a computer file within a directory of files of the software project. Referring to FIG. 3D, the software application may generate a prompt 350 which includes the virtual table 330 (e.g., the JSON representation of the virtual table 330, etc.), a description of a task 352 to be performed by the ML service 224, a description of the UI 354 that is to be generated, and the like. The description of the task 352 and the description of the UI 354 may be static content, while the virtual table 330 may be unique.

In this example, the prompt 350 may be based on a prompt template that includes inputs about the UI design (such as components, layout, and attributes), descriptions of reusable components and APIs, component scripts, and any constraints or limitations (e.g., coding standards, framework preferences, security requirements, and the like).

The ML service 224 may receive the prompt 350 and generate the source code 225 in response. For example, the ML service 224 may be a large language model (LLM) which can generate executable source code in response to receiving the prompt 350. The executable source code may include code for rendering UI components according to a UI layout specified in the design diagram. The source code may include HTML code, CSS code, JavaScript code, or the like. The source code 225 may be stored within a software project.

For example, the software project may include a plurality of files, folders, and the like, which are arranged in a project directory 360. The software application 222 may identify the correct folder and computer file 362 where the source code 225 should be added and store the source code 225 within the computer file 362. The software application 222 may build a graph of the project directory 360 by generating nodes in the graph that correspond to the folders. In addition, for each folder, the software application may generate a node that depends on the node corresponding to the folder. The dependency may be represented by an edge between the node of the folder and the node of the computer file.

The software application 222 may embed folder content into the graph, for example, names, IDs, content summaries, and the like, of the folders into the nodes in the graph which correspond to the folders. The software application 222 may compare the name of a UI component represented by the source code to content within the nodes to identify which node or nodes correspond to the source code 225, and insert the source code 225 into a corresponding file of the identified node or nodes. The graph may be built by recursively accessing the project directory 360, treating each folder as a parent node and each file as a leaf node. As it traverses the project directory 360, the software application 222 collects metadata (like file names, directory names, and attributes), constructs a hierarchical tree structure, and stores this information. In some embodiments, the software application 222 may perform a graph search of the graph, for example, using an LLM to identify the related node or nodes in the graph.

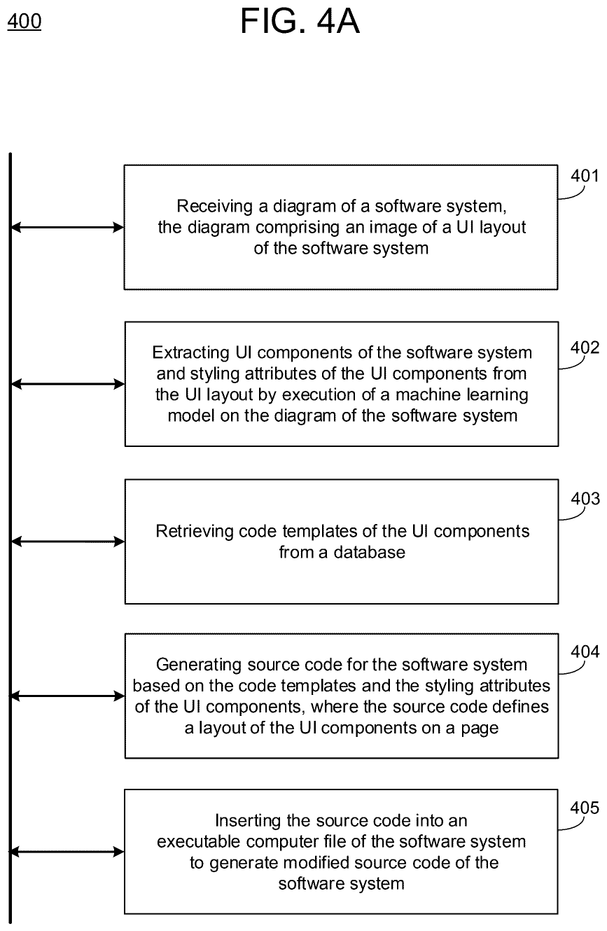

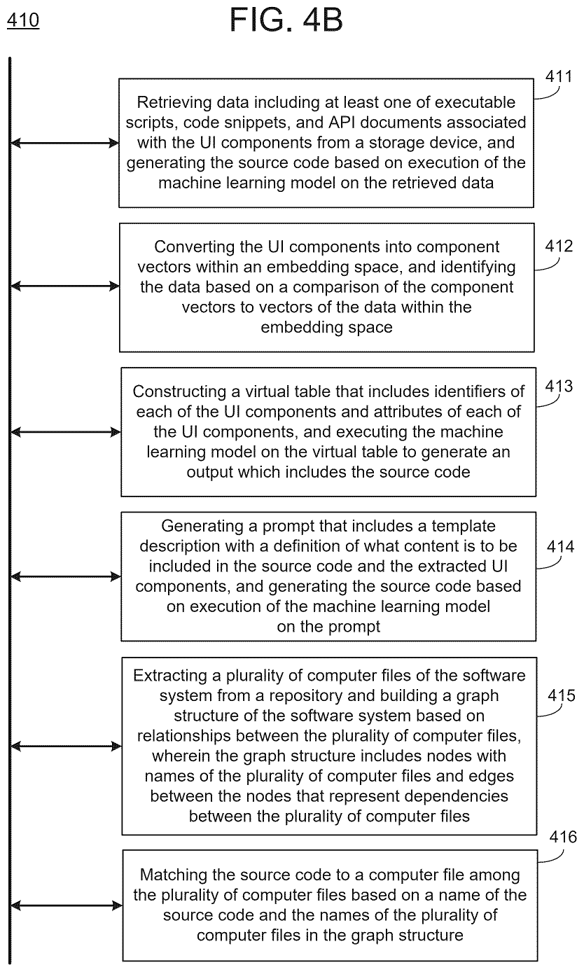

FIG. 4A illustrates a flow diagram of a method 400, according to example embodiments. Referring to FIG. 4A, in 401, the method may include receiving a diagram of a software system, the diagram comprising an image of a user interface (UI) layout of the software. In 402, the method may include extracting UI components of the software system and styling attributes of the UI components from the UI layout by execution of a machine learning model on the diagram of the software system. In 403, the method may include retrieving code templates of the UI components from a database. In 404, the method may include generating source code for the software system based on the code templates and the styling attributes of the UI components, where the source code defines a layout of the UI components on a page. In 405, the method may include inserting the source code into an executable computer file of the software system to generate modified source code of the software system.

FIG. 4B illustrates a flow diagram of a method 410, according to example embodiments. Referring to FIG. 4B, in 411, the method may include retrieving data including at least one of executable scripts, code snippets, and API documents associated with the UI components from a storage device, and generating the source code based on execution of the machine learning model on the retrieved data. In 412, the method may include converting the UI components into component vectors within an embedding space, and identifying the data based on a comparison of the component vectors to vectors of the data within the embedding space.

In 413, the method may include constructing a virtual table that includes identifiers of each of the UI components and attributes of each of the UI components and executing the machine learning model on the virtual table to generate an output which includes the source code. In 414, the method may include generating a prompt that includes a template description with a definition of what content is to be included in the source code and the extracted UI components, and generating the source code based on execution of the machine learning model on the prompt.

In 415, the method may include extracting a plurality of computer files of the software system from a repository and building a graph structure of the software system based on relationships between the plurality of computer files, wherein the graph structure includes nodes with names of the plurality of computer files and edges between the nodes that represent dependencies between the plurality of computer files. In 416, the method may include matching the source code to a computer file among the plurality of computer files based on a name of the source code and the names of the plurality of computer files in the graph structure.

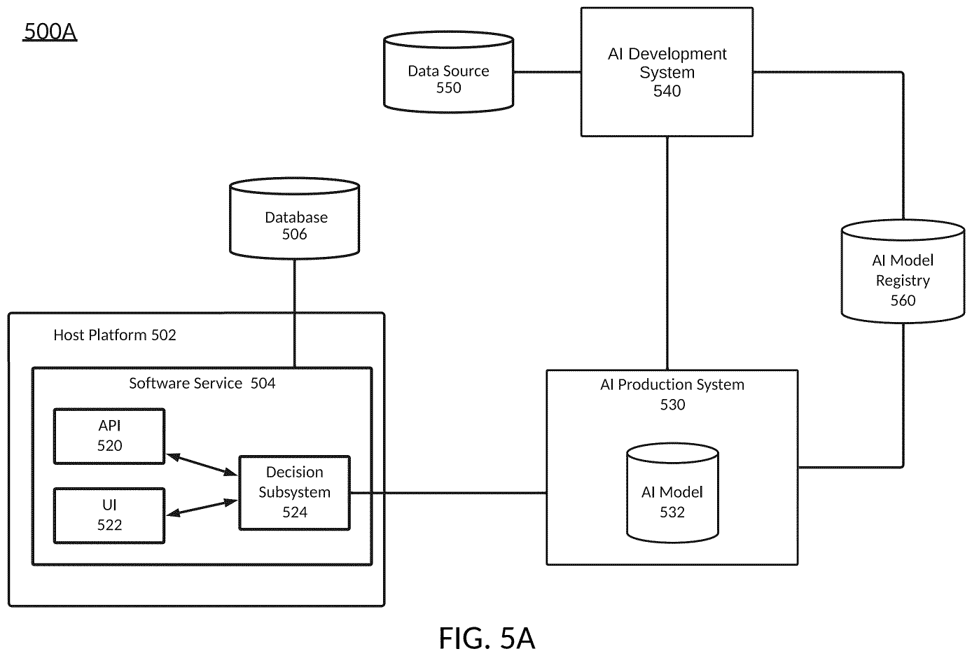

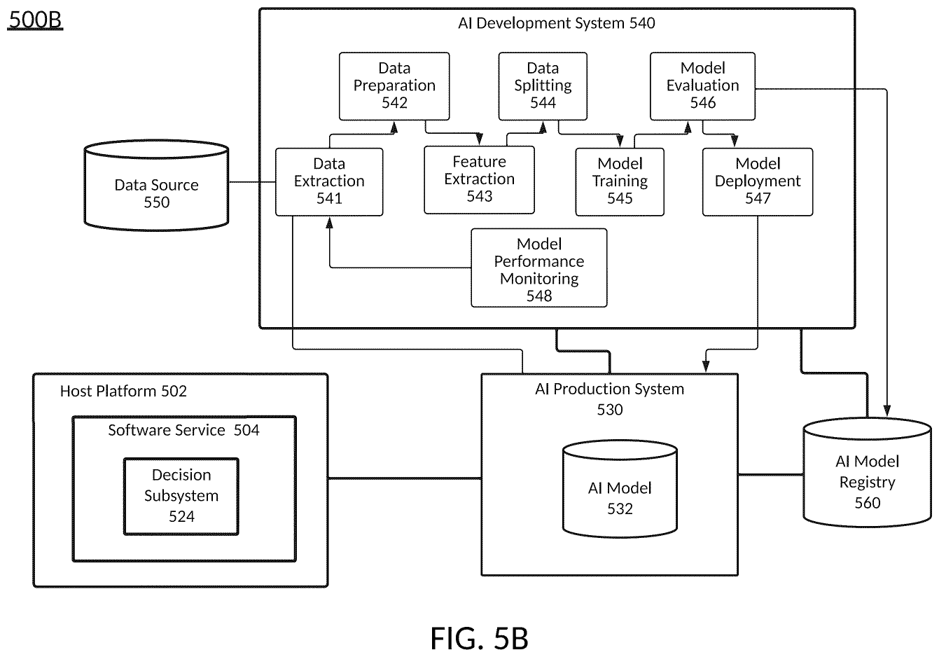

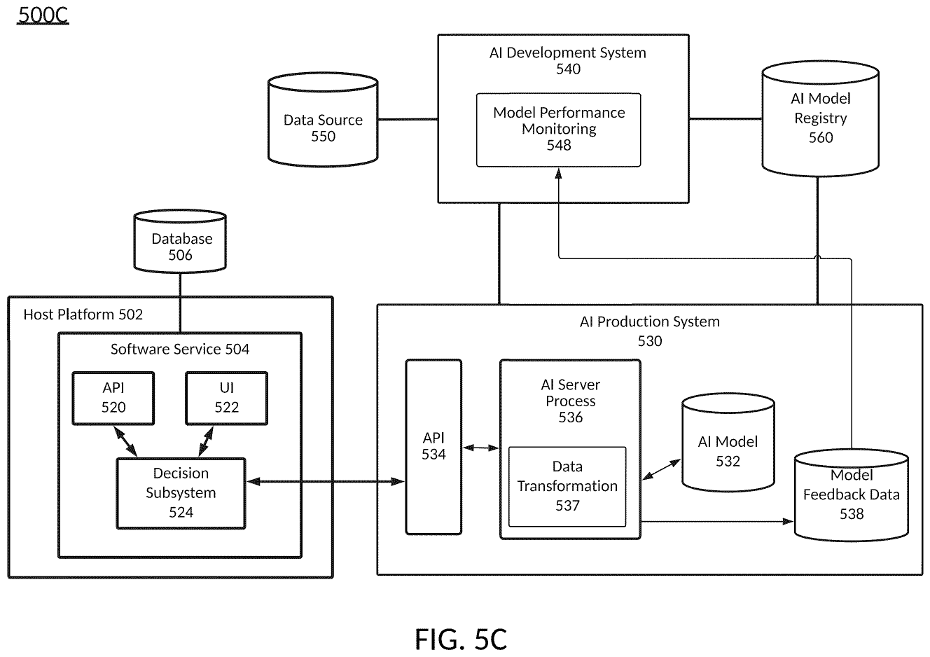

Detailed descriptions of training a machine learning model and executing a machine learning model are further described and depicted herein. The training and execution of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
receiving a diagram of a software system, the diagram comprising an image of a user interface (UI) layout of the software system;
extracting UI components of the software system and styling attributes of the UI components from the UI layout by execution of a machine learning model on the diagram of the software system;
retrieving code templates of the UI components from a database;
generating source code for the software system based on the code templates and the styling attributes of the UI components, where the source code defines a layout of the UI components on a page; and
inserting the source code into an executable computer file of the software system to generate modified source code of the software system.

2. The method of claim 1, wherein the retrieving comprises retrieving data including at least one of executable scripts, code snippets, and application programming interface (API) documents associated with the UI components from a storage device, wherein the generating the source code comprises generating the source code based on execution of the machine learning model on the retrieved data.

3. The method of claim 2, wherein the method further comprises converting the UI components into component vectors within an embedding space, and identifying the data based on a comparison of the component vectors to vectors of the data within the embedding space.

4. The method of claim 1, wherein the extracting comprises constructing a virtual table that includes identifiers of each of the UI components and attributes of each of the UI components, and the generating the source code comprises executing the machine learning model on the virtual table to generate an output which includes the source code.

5. The method of claim 1, further comprising generating a prompt that includes a template description with a definition of what content is to be included in the source code and the extracted UI components, wherein the generating the source code further comprises generating the source code based on execution of the machine learning model on the prompt.

6. The method of claim 1, further comprising extracting a plurality of computer files of the software system from a repository and building a graph structure of the software system based on relationships between the plurality of computer files, wherein the graph structure includes nodes with names of the plurality of computer files and edges between the nodes that represent dependencies between the plurality of computer files.

7. The method of claim 6, further comprising matching the source code to a computer file among the plurality of computer files based on a name of the source code and the names of the plurality of computer files in the graph structure.

8. A computer system comprising:
a processor set;
a set of one or more computer-readable storage media; and
program instructions, collectively stored in the set of one or more storage media, that cause the processor set to perform computer operations comprising:
receiving a diagram of a software system, the diagram comprising an image of a user interface (UI) layout of the software system;
extracting UI components of the software system and styling attributes of the UI components from the UI layout by execution of a machine learning model on the diagram of the software system;
retrieving code templates of the UI components from a database;
generating source code for the software system based on the code templates and the styling attributes of the UI components, where the source code defines a layout of the UI components on a page; and
inserting the source code into an executable computer file of the software system to generate modified source code of the software system.

9. The computer system of claim 8, wherein the retrieving comprises retrieving data including at least one of executable scripts, code snippets, and application programming interface (API) documents associated with the UI components from a storage device, wherein the generating the source code comprises generating the source code based on execution of the machine learning model on the retrieved data.

10. The computer system of claim 9, wherein the computer operations further comprise converting the UI components into component vectors within an embedding space, and identifying the data based on a comparison of the component vectors to vectors of the data within the embedding space.

11. The computer system of claim 8, wherein the extracting comprises constructing a virtual table that includes identifiers of each of the UI components and attributes of each of the UI components, and the generating the source code comprises executing the machine learning model on the virtual table to generate an output which includes the source code.

12. The computer system of claim 8, further comprising generating a prompt that includes a template description with a definition of what content is to be included in the source code and the extracted UI components, wherein the generating the source code further comprises generating the source code based on execution of the machine learning model on the prompt.

13. The computer system of claim 8, wherein the computer operations further comprise extracting a plurality of computer files of the software system from a repository and building a graph structure of the software system based on relationships between the plurality of computer files, wherein the graph structure includes nodes with names of the plurality of computer files and edges between the nodes that represent dependencies between the plurality of computer files.

14. The computer system of claim 13, wherein the computer operations further comprise matching the source code to a computer file among the plurality of computer files based on a name of the source code and the names of the plurality of computer files in the graph structure.

15. A computer program product comprising:
a set of one or more computer-readable storage media; and
program instructions, collectively stored in the set of one or more computer-readable storage media, for causing a processor set to perform computer operations comprising:
receiving a diagram of a software system, the diagram comprising an image of a user interface (UI) layout of the software system;
extracting UI components of the software system and styling attributes of the UI components from the UI layout by execution of a machine learning model on the diagram of the software system;
retrieving code templates of the UI components from a database;
generating source code for the software system based on the code templates and the styling attributes of the UI components, where the source code defines a layout of the UI components on a page; and
inserting the source code into an executable computer file of the software system to generate modified source code of the software system.

16. The computer program product of claim 15, wherein the retrieving comprises retrieving data including at least one of executable scripts, code snippets, and application programming interface (API) documents associated with the UI components from a storage device, wherein the generating the source code comprises generating the source code based on execution of the machine learning model on the retrieved data.

17. The computer program product of claim 16, wherein the computer operations further comprise converting the UI components into component vectors within an embedding space, and identifying the data based on a comparison of the component vectors to vectors of the data within the embedding space.

18. The computer program product of claim 15, wherein the extracting comprises constructing a virtual table that includes identifiers of each of the UI components and attributes of each of the UI components, and the generating the source code comprises executing the machine learning model on the virtual table to generate an output which includes the source code.

19. The computer program product of claim 15, further comprising generating a prompt that includes a template description with a definition of what content is to be included in the source code and the extracted UI components, wherein the generating the source code further comprises generating the source code based on execution of the machine learning model on the prompt.

20. The computer program product of claim 15, wherein the computer operations further comprise extracting a plurality of computer files of the software system from a repository and building a graph structure of the software system based on relationships between the plurality of computer files, wherein the graph structure includes nodes with names of the plurality of computer files and edges between the nodes that represent dependencies between the plurality of computer files.
